(19) United States
(12) Patent Application Publication
(10) Pub. No.: US 2017/0094171 A1
(43) Pub. Date: Mar. 30, 2017

(54) Integrated Solutions For Smart Imaging

(71) Applicant: Google Inc., Mountain View, CA (US)

(72) Inventors: Suk Hwan Lim, Mountain View, CA (US); Chung Chun Wan, San Jose, CA (US); Choon Ping Chng, Los Altos, CA (US); Blaise Aguera-Arcas, Seattle, WA (US)

(21) Appl. No.: 15/273,427

(22) Filed: Sep. 22, 2016

Related U.S. Application Data
(60) Provisional application No. 62/234,010, filed on Sep. 28, 2015.

(51) Int. Cl. H04N 5/232; G06K 9/00

(52) U.S. Cl. CPC H04N 5/23245; H04N 5/23222; G06K 9/00664

(57) ABSTRACT

An integrated stacked and/or abutted sensor, memory and processing hardware camera solution is described. The sensor is to receive light from an image and generate electronic pixels from the light. The processing hardware is to process the electronic pixels to: a) recognize a scene from the image in a lower quality image mode; b) trigger actions by the camera solution in response to the recognition of the scene, the actions including: i) transitioning the camera solution from the lower quality image mode to a higher quality image mode to capture a higher quality version of the image; and, ii) forwarding from the camera solution important imagery and not forwarding from the camera solution unimportant imagery.

### RELATED CASES

[000.5] This application claims the benefit of U.S. Provisional Application No. 62/234,010, titled “Integrated Solutions For Smart Imaging”, filed Sep. 28, 2015, which is incorporated by reference in its entirety.

### BACKGROUND

As observed in FIG. 1, intelligent and/or sophisticated image related tasks 100 have traditionally been performed entirely by a computing system's higher performance data processing components such as its general purpose processing core(s) 102 and/or its image signal processor (ISP) 103.

A problem with performing all such tasks 100 within these components 102, 103 is the amount of power consumed moving image data within the system. Specifically, entire images of data typically need to be forwarded 106 from the camera 101 to the ISP directly 103 or into system memory 104. The movement of such large quantities of data within the system consumes large amounts of power which, in the case of battery operated devices, can dramatically reduce the battery life of the device.

Compounding the inefficiency is that often times much of the image data is of little importance or value. For example, consider an imaging task that seeks to analyze a small area of the image. Here, although just a small area of the image is of interest to the processing task, the entire image will be forwarded through the system. The small region of interest is effectively parsed from the larger image only after the system has expended significant power moving large amounts of useless data outside the region.

Another example is the initial identification of a “looked for” feature within an image (e.g., the initial identification of the region of interest in the example discussed immediately above). Here, if the looked for feature is apt to be present in the imagery taken by the camera only infrequently, continuous streams of entire images without the feature will be forwarded through the system before the feature ultimately presents itself. As such, again, large amounts of data that are of no use or value are being moved through the system, which can dramatically reduce the power efficiency of the device.

Additionally all camera control decisions, such as whether to enter a camera into a particular mode, have traditionally been made by the general purpose processing core 102. As such highly adaptive camera control functions (e.g., in which a camera switches between various modes frequently) can generate heavy camera control traffic 107 that is directed through the system toward the camera 101. Such highly adaptive functions may even be infeasible because of the substantial delay that exists between the recognizing of an event that causes a camera to change modes and when any new command is ultimately received by the camera 101.

### SUMMARY

An integrated stacked and/or abutted sensor, memory and processing hardware camera solution is described. The sensor is to receive light from an image and generate electronic pixels from the light. The processing hardware is to process the electronic pixels to: a) recognize a scene from the image in a lower quality image mode; b) trigger actions by the camera solution in response to the recognition of the scene, the actions including: i) transitioning the camera solution from the lower quality image mode to a higher quality image mode to capture a higher quality version of the image; and, ii) forwarding from the camera solution important imagery and not forwarding from the camera solution unimportant imagery.

An apparatus is described that comprises means for receiving light from an image and generating electronic pixels from the light. The apparatus also includes means for processing the electronic pixels, the means for processing including means for recognizing a scene from the image in a lower quality image mode and means for triggering actions in response to the recognizing. The actions include: i) transitioning to from the lower quality image mode to a higher quality image mode to capture a higher quality version of the image; and, ii) forwarding important imagery and not forwarding unimportant imagery. The means for receiving light, the means for processing and a memory are stacked and/or abutted into an integrated camera solution.

### LIST OF FIGURES

The following description and accompanying drawings are used to illustrate embodiments of the invention. In the drawings:

FIG. 1 shows a prior art system having a camera;

FIG. 2 shows an improved system having an integrated camera solution;

FIGS. 3a(i) and 3a(ii) show different mechanical designs of an integrated camera solution;

FIG. 3b shows a logical design for an integrated camera solution;

FIG. 4 shows a functional framework for an integrated camera solution;

FIG. 5 shows a first method performed by an integrated camera solution;

FIG. 6 shows a second method performed by an integrated camera solution;

FIG. 7 shows a computing system.

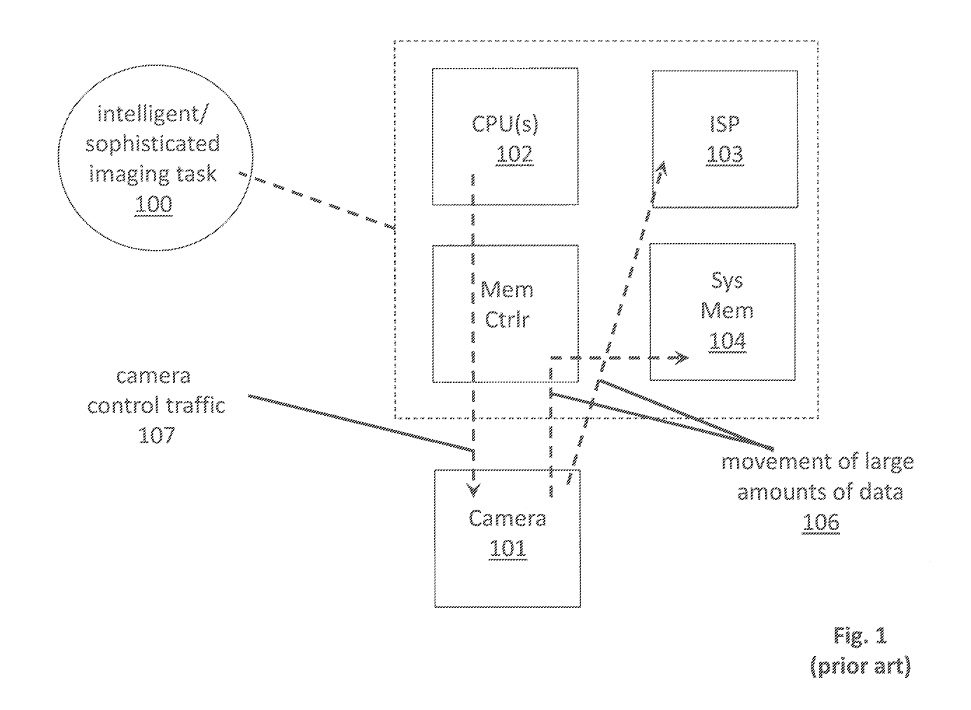

### DESCRIPTION

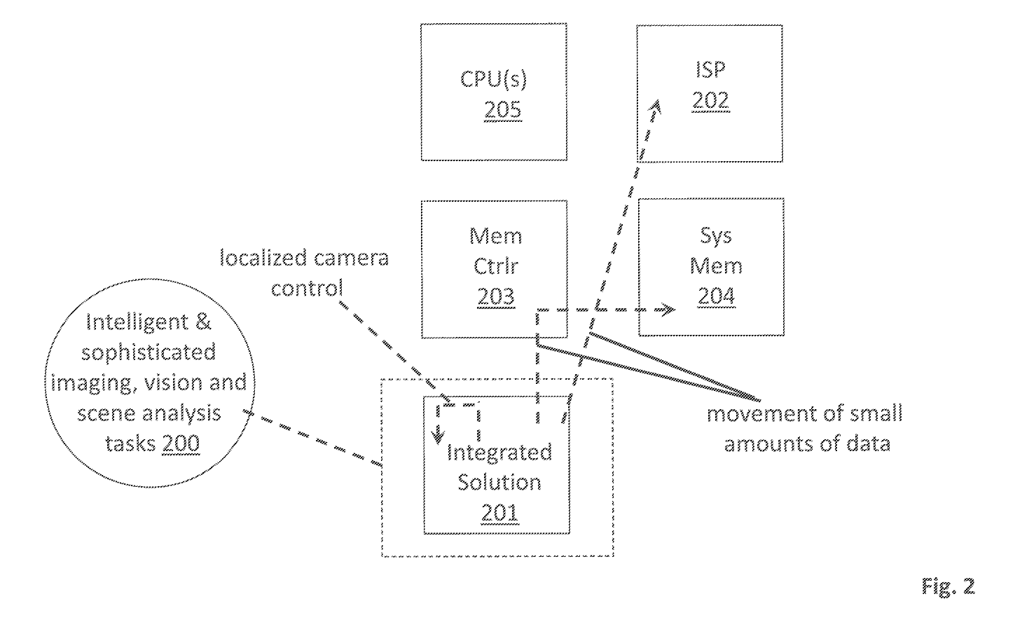

FIG. 2 depicts an improved system where a sensor, memory and processing hardware 201 (hereinafter, “integrated solution” or “integrated camera solution”) that are mechanically integrated very closely to one another (e.g., by being stacked and/or abutted to one another), is able to perform various intelligent/sophisticated processing tasks 200 so as to improve the power efficiency of the device.

One such task is the ability to identify “looked-for” image features within the imagery being taken by the integrated solution 201. Another task is the ability to determine specific operating modes “on the fly” from analysis of imagery that has just been taken by the integrated solution 201. Each of these is discussed at length below.

With the ability to identify looked for image features with the integrated solution 201, image data that is of no interest or importance can be discarded by the integrated solution 201 thereby preventing it from being forwarded elsewhere through the system.

For example, recalling the problematic examples discussed just above in the Background section, if an image's region of interest can be identified by the integrated solution 201, the area of the image that is outside the region of interest can be completely discarded by the integrated solution 201—leaving only the region of interest to be forwarded to other components within the system for further processing. Likewise, entire images that do not have any content of importance can also be discarded in their entirety by the integrated solution 201.

As another example, entire frames can be passed or discarded based on whether or not their content has any features of interest. As such, frames having pertinent information are passed from the integrated solution 201 to other components of the system (e.g., system memory 204, a display, etc.). Frames deemed not to contain any pertinent information are discarded.

As such, the ability to identify looked-for features with the integrated solution 201 provides for a system that, ideally, only forwards data having some importance or value elsewhere through the system. By preventing the forwarding of data having no importance or value through the system, the efficiency of the system is greatly improved as compared to traditional prior art systems.

The functionality of identifying looked for features with the integrated solution 201 may also be extended, at least in some cases, to perform any associated follow-on image processing tasks with the integrated solution 201. One particularly pertinent follow-on processing task may be compression. Here, once pertinent image information has been identified by the integrated solution 201, the information may be further compressed by the integrated solution 201 to reduce its total data size in preparation for its forwarding to other components within the system. Thus, not only may efficiencies be realized by eliminating information of no importance for forwarding, but also, reducing the size of the information that is pertinent and is forwarded.

Further still, different parts of a feature of interest may be compressed at different compression ratios (e.g., sections of the image that are more quality sensitive may be compressed at a lower compression ratio while other sections of the image that are less quality sensitive may be compressed at a higher compression ratio). Generally, images (e.g., entire frames or portions thereof) that are more sensitive to quality may be compressed with lower compression ratios while images (e.g., frames or portions thereof) that are less sensitive to quality may be compressed with greater compression ratios.

In yet other cases, all of the image processing intelligence for a particular function may be performed by the integrated solution 201. For instance, not only may a region of interest be identified by the integrated solution 201, but also, whatever analysis of the region of interest that is to take place once it has been identified is also performed by the integrated solution 201. In this case, little or no image information at all (important or otherwise) is forwarded through the system because the entire task has been performed by the integrated solution 201. In this respect, power reduction efficiency is practically ideal as compared to the prior art approaches described in the Background.

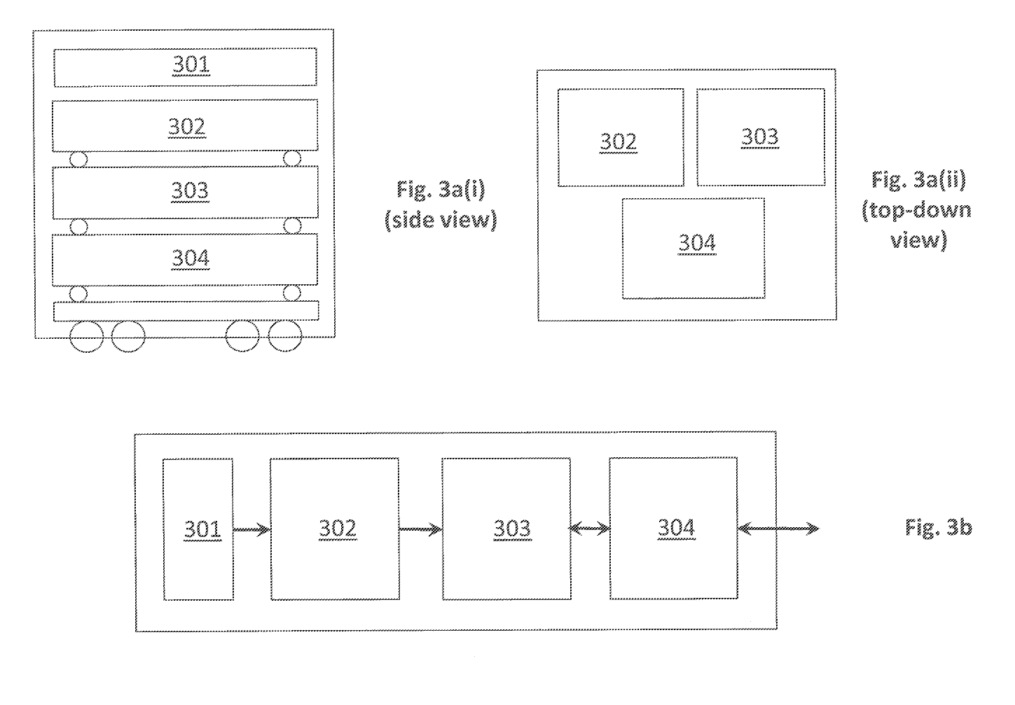

In order to identify looked for features within an image (or other extended image processing functions) with the integrated solution 201, some degree of processing intelligence/sophistication is integrated into the integrated solution 201. FIGS. 3a(i), 3a(ii) and 3b show some possible embodiments where an imaging device has been enhanced with non traditional hardware and/or software components so that the device can perform intelligent/sophisticated image processing tasks consistent with the improvements discussed above.

FIGS. 3a(i) and 3a(ii) show embodiments of possible mechanical designs for a solution having integrated processing intelligence. As observed in FIG. 3a(i), the integrated solution includes traditional camera optics and servo motors 301 (the later, e.g., for auto-focus functions) and an image sensor 302. The integrated solution also includes, however, integrated memory 303 and processing intelligence hardware 304.

As observed in FIG. 3a(i), the mechanical design is implemented with stacked semiconductor chips 302-304. Also as observed in FIG. 3a(i) the memory 303 and processing intelligence hardware 304 are within the same package having the camera optics and image sensor.

In other embodiments, such as observed in FIG. 3a(ii), the sensor 302, memory 303 and processing intelligence hardware 304 may be placed very close to one another, e.g., by being abutted next to one another (for simplicity FIG. 3a(ii) does not show the optics/motors 301 which may be positioned above any one or more of the sensor 302, memory 303 and processing intelligence hardware 304). Various combinations of stacking and abutment may also exist to provide for a compact mechanical design in which the various elements are placed in very close proximity to one another. In combination or alternatively, e.g., as an extreme form of abutment, various components may be integrated on a same semiconductor die (e.g., the image sensor and processing intelligence hardware may be integrated on a same die).

FIG. 3b shows a functional design for the integrated solution of FIG. 3a. As observed in FIG. 3b, the camera optics 301 process incident light that is received by the image sensor 302 which generates pixelated image data in response thereto. The image sensor forwards the pixelated image data into a memory 303. The image data is then processed by the processing intelligence hardware 304.

The processing intelligence hardware 304 can take on various different forms depending on implementation. At one extreme, the processing intelligence hardware 304 includes one or more processors and/or controllers that execute program code (e.g., that is also stored in memory 303 and/or in a non volatile memory, e.g., within the camera (not shown)). Here, software and/or firmware routines written to perform various complex tasks are stored in memory 303 and are executed by the processor/controller in order to perform the specific complex function.

At the other extreme, the processing intelligence hardware 304 is implemented with dedicated (e.g., custom) hardware logic circuitry such as application specific integrated specific (ASIC) custom hardware logic and/or programmable hardware logic (e.g., field programmable gate array (FPGA) logic, programmable logic device (PLD) logic and/or programmable logic array (PLA) logic).

In yet other implementations, some combination between these two extremes (processor(s) that execute program code vs. dedicated hardware logic circuitry) can be used to effectively implement the processing intelligence hardware component 304.

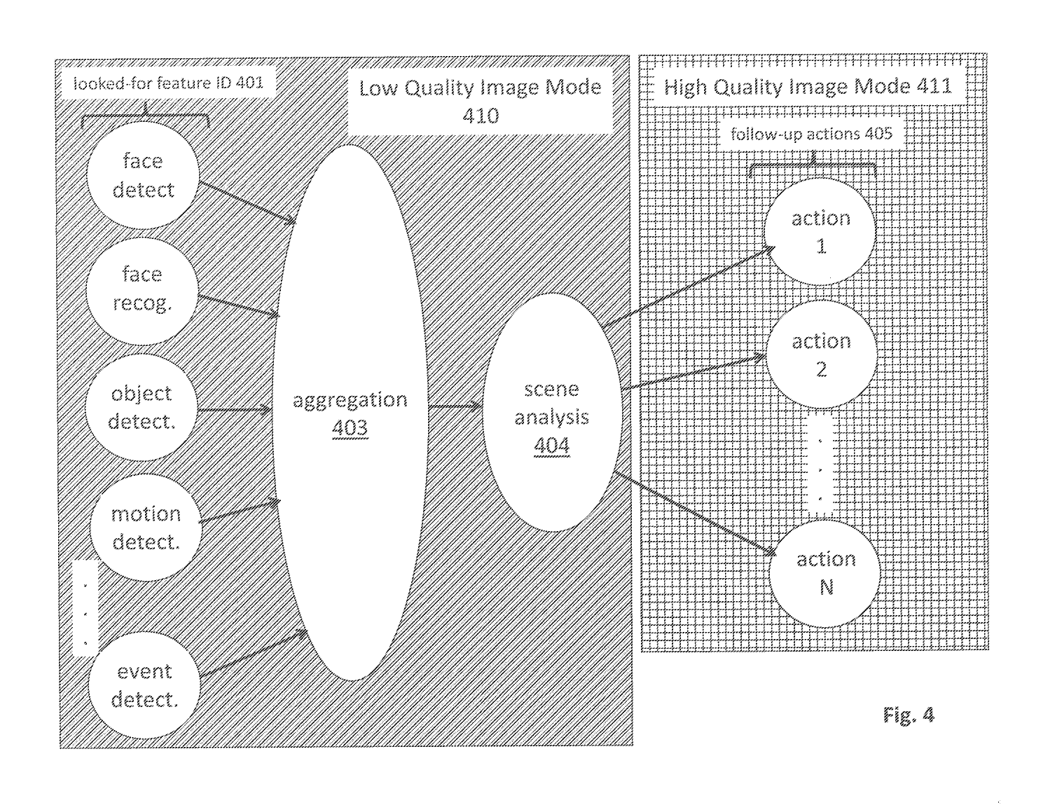

FIG. 4 shows a functional framework for various sophisticated tasks that may be performed by the processing intelligence hardware 304 as discussed just above.

As alluded to above, various looked-for features may be found by the integrated solution. The associated looked-for feature processes 401 may include, e.g., face detection (detecting the presence of any face), face recognition (detecting the presence of a specific face), facial expression recognition (detecting a particular facial expression), object detection or recognition (detecting the presence of a generic or specific object), motion detection or recognition (detecting a general or specific kind of motion), event detection or recognition (detecting a general or specific kind of event), image quality detection or recognition (detecting a general or specific level of image quality).

The looked for feature processes 401 may be performed, e.g., concurrently, serially, and/or may be dependent on various conditions (e.g., a facial recognition function may only be performed if specifically requested by a processing core and/or application and/or user).

As observed in FIG. 4, in various embodiments, the looked for feature processes 401 may be performed before a looked for feature has been found in a low quality image mode 410 to conserve power consumption. Here, a low quality image mode may be achieved with, e.g., any one or more of lower image resolution, lower image frame rate, and/or lower pixel bit depth. As such, the image sensor 302 may have associated setting controls to effect lower power vs. higher power operation.

Consider as an example a system that has been configured to identify various looked for features within a sequence of images being captured by the integrated solution, but where no such features have currently been found. In this mode, the integrated solution may continually take pictures of images to feed the looked for feature processes 401 with the expectation that a looked for feature may eventually present itself.

The taking of these pictures, however, is deliberately performed in a low picture quality mode to consume less power since there is also a likelihood that a number of images being captured may not contain any looked for feature. Since it does not make sense to consume significant power taking pictures of images whose content has no value, low quality mode is used prior to the discovery of a looked for feature to conserve power usage. Here, in many cases, various kinds of looked for features can be identified from a low quality image.

The outputs from the one or more of the looked-for feature processes 401 are provided to an aggregation layer 403 that combines outputs from various ones of the looked for feature processes 401 to enable a more comprehensive looked for scene (or “scene analysis”) function 404. For instance, consider a system that is designed to start streaming video if two particular people are identified in an image. Here, a first of the looked for feature processes 401 will identify the first person and a second of the looked for feature processes will identify the second person.

The outputs of both processes are aggregated 403 to enable a scene analysis function 404 that will raise a flag if both looked for features are found (i.e., both people have been identified in the image). Here, various ones of the looked for feature processes can be aggregated 403 to enable one or more scene analysis configurations (e.g., a first scene analysis that looks for two particular people and a particular object within an image, a second scene analysis that looks for three specific people, etc.).

Upon the scene analysis function 404 recognizing that a looked for scene has been found, the scene analysis will “trigger” the start of one or more additional follow-up actions 405. For instance, recall the example above where the integrated solution is to begin streaming video if two people are identified in the images being analyzed. Here, the follow-up action corresponds to the streaming of the video.

In many cases, as indicated in FIG. 4, the follow-up action will include changing the quality mode of the images being taken from a low quality mode 410 to a high quality mode 411.

Here, recall that low quality mode 410 may be used to analyze images for looked for features before any looked for scenes are found because such images are apt to not contain looked for information, and therefore it does not make sense to consume large amounts of power taking such images. After a looked for scene has been found, however, the images being taken by the integrated solution are potentially important and therefore it is justifiable to consume more power to take later images at higher quality. Transitioning to a higher quality image mode may include, for instance, any one or more of increasing the frame rate, increasing the image resolution, and/or increasing the bit depth. In one embodiment, e.g., to conserve power in the high quality mode, the only pixel areas of the image sensor that are enabled during a capture mode are the pixel areas where a feature of interest is expected to impinge upon the surface area the image sensor. Again, the image sensor 302 is presumed to include various configuration settings to enable rapid transition of such parameters. Note that making the decision to transition the integrated solution between low quality and high quality image modes corresponds to localized, adaptive imaging control which is a significant improvement over prior art approaches

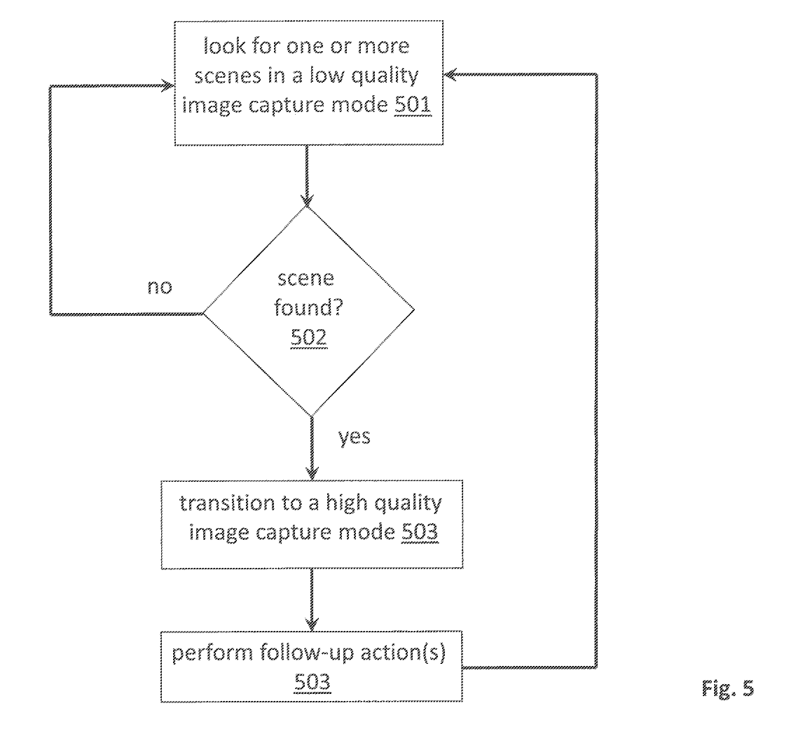

FIG. 5 therefore shows a general process in which images are taken by a camera in a low quality image capture mode while concurrently looking for one or more features that characterize a particular one or more scenes that the system has been configured to look for 501. So long as a looked for scene is not found 502, the system continues to capture images in low quality/low power mode 501. Once a looked for scene is recognized 502, however, the system transitions into a higher quality image capture mode 503 and takes some additional action(s) 504. Here, in various embodiments, the entire methodology of FIG. 5 can be performed by the integrated solution.

Some examples of the additional actions 504 that may take place in response to a particular scene being identified include any one or more the following: 1) identifying an area of interest within an image (e.g., the immediate area surrounding one or more looked for features within the image); 2) parsing an area of interest within an image and forwarding it to other (e.g., higher performance) processing components within the system; 3) discarding the area within an image that is not of interest; 4) compressing an image or portion of an image before it is forwarded to other components within the system; 5) taking a particular kind of image (e.g., a snapshot, a series of snapshots, a video stream); and, 6) changing one or more camera settings (e.g., changing the settings on the servo motors that are coupled to the optics to zoom-in, zoom-out or otherwise adjust the focusing/optics of the camera; changing an exposure setting; trigger a flash). Again, all of these actions can be taken under the control of the processing intelligence that exists at the camera-level.

Although embodiments above have stressed the entering of a high quality image capture mode after a looked for scene has been identified, various embodiments may not require such a transition and various one of the follow up actions 504 can take place while images are still being captured in a lower quality image capture mode.

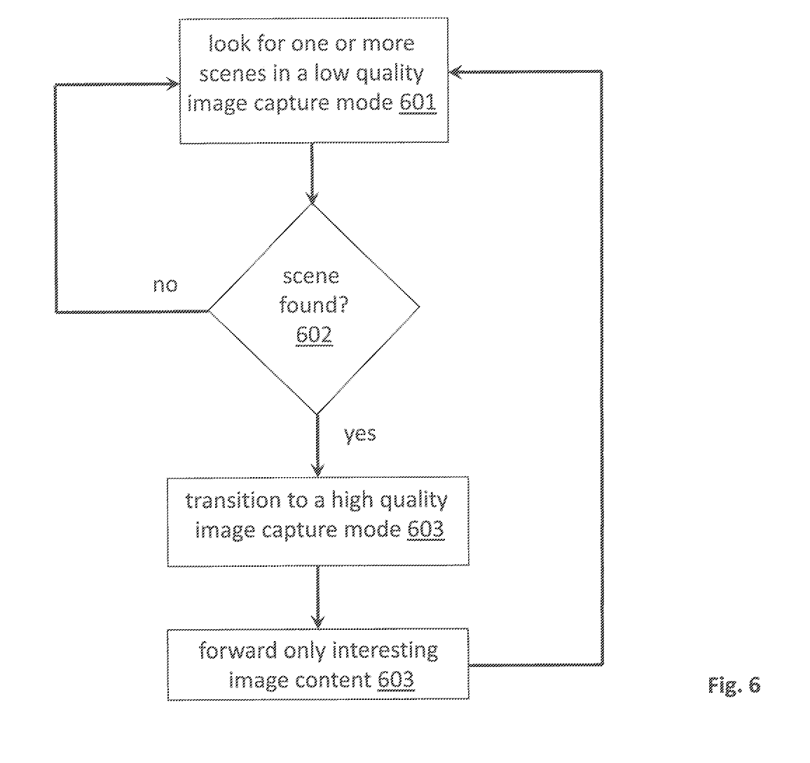

FIG. 6 shows a process like FIG. 5 but where the additional action includes forwarding only image content of interest 604.

Note also that the integrated solution may be a stand alone device that is not itself integrated into a computer system. For example, the integrated solution may have, e.g., a wireless I/O interface that forwards image content consistent with the teachings above directly to a stand alone display device.

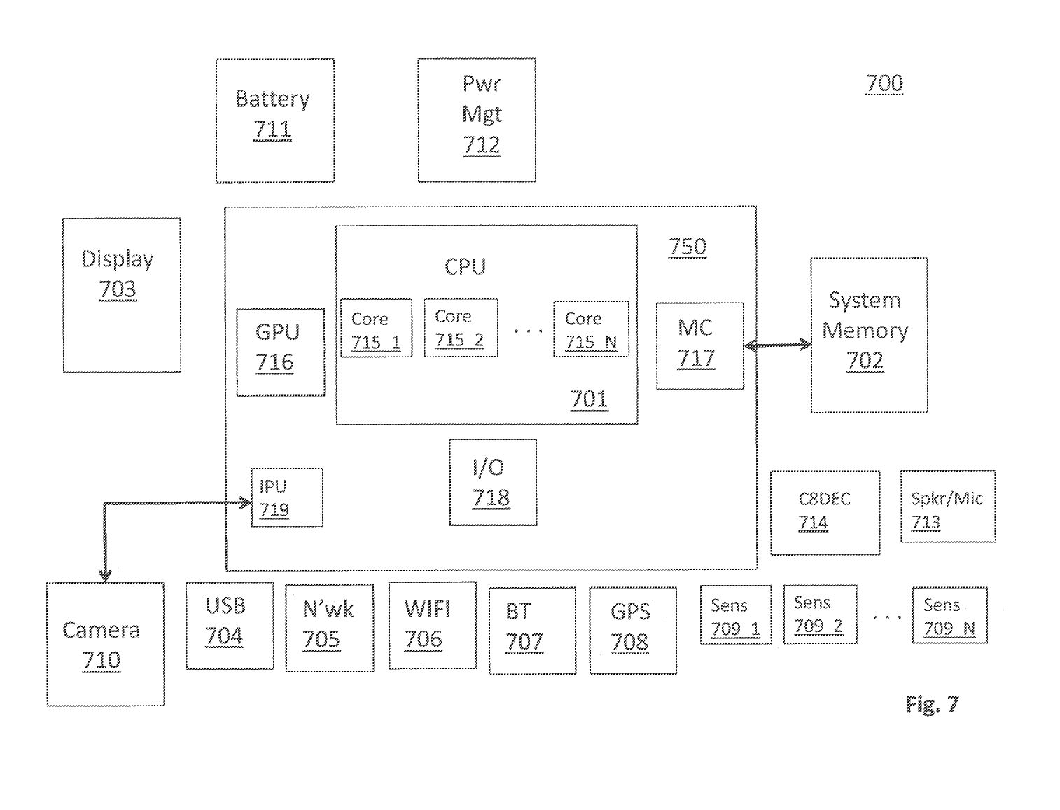

FIG. 7 provides an exemplary depiction of a computing system. Many of the components of the computing system described below are applicable to a computing system having an integrated camera and associated image processor (e.g., a handheld device such as a smartphone or tablet computer). Those of ordinary skill will be able to easily delineate between the two.

As observed in FIG. 7, the basic computing system may include a central processing unit 701 (which may include, e.g., a plurality of general purpose processing cores 715_1 through 715_N and a main memory controller 717 disposed on a multi-core processor or applications processor), system memory 702, a display 703 (e.g., touchscreen, flat-panel), a local wired point-to-point link (e.g., USB) interface 704, various network I/O functions 705 (such as an Ethernet interface and/or cellular modem subsystem), a wireless local area network (e.g., WiFi) interface 706, a wireless point-to-point link (e.g., Bluetooth) interface 707 and a Global Positioning System interface 708, various sensors 709_1 through 709_N, one or more cameras 710, a battery 711, a power management control unit 724, a speaker and microphone 713 and an audio coder/decoder 714.

An applications processor or multi-core processor 750 may include one or more general purpose processing cores 715 within its CPU 701, one or more graphical processing units 716, a memory management function 717 (e.g., a memory controller), an I/O control function 718 and an image processing unit 719. The general purpose processing cores 715 typically execute the operating system and application software of the computing system. The graphics processing units 716 typically execute graphics intensive functions to, e.g., generate graphics information that is presented on the display 703. The memory control function 717 interfaces with the system memory 702 to write/read data to/from system memory 702. The power management control unit 724 generally controls the power consumption of the system 700.

The camera 707 may be implemented as an integrated stacked and/or abutted sensor, memory and processing hardware solution as described at length above.

Each of the touchscreen display 703, the communication interfaces 704-707, the GPS interface 708, the sensors 709, the camera 710, and the speaker/microphone codec 713, 714 all can be viewed as various forms of I/O (input and/or output) relative to the overall computing system including, where appropriate, an integrated peripheral device as well (e.g., the one or more cameras 710). Depending on implementation, various ones of these I/O components may be integrated on the applications processor/multi-core processor 750 or may be located off the die or outside the package of the applications processor/multi-core processor 750.

In an embodiment one or more cameras 710 includes a depth camera capable of measuring depth between the camera and an object in its field of view. Application software, operating system software, device driver software and/or firmware executing on a general purpose CPU core (or other functional block having an instruction execution pipeline to execute program code) of an applications processor or other processor may perform any of the functions described above.

Embodiments of the invention may include various processes as set forth above. The processes may be embodied in machine-executable instructions. The instructions can be used to cause a general-purpose or special-purpose processor to perform certain processes. Alternatively, these processes may be performed by specific hardware components that contain hardwired logic for performing the processes, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, FLASH memory, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

1. A machine readable storage medium storing program code for an integrated camera solution, wherein, when the program code is processed by processing hardware of the camera solution, the camera solution performs a method, comprising:
processing electronic pixels with the processing hardware, the integrated camera solution comprising the processing hardware, a memory and a sensor, the processing hardware, memory and sensor being stacked and/or abutted, the electronic pixels generated by the sensor in response to the sensor receiving light from an image, the processing including:
recognizing a scene from the image in a lower quality image mode;
triggering actions by the camera solution in response to the recognizing of the scene, the actions comprising:
i) transitioning from the lower quality image mode to a higher quality image mode to capture a higher quality version of the image; and,
ii) forwarding from the camera solution important imagery and not forwarding from the camera solution unimportant imagery.

2. The machine readable medium of claim 1 wherein the method further comprises reading the electronic pixels from the memory, the electronic pixels stored in the memory to capture the image.

3. The machine readable medium of claim 1 wherein the important imagery of
ii) comprises a first frame having a feature of interest and the unimportant imagery of ii) comprises a second frame that does not have the feature of interest.

4. The machine readable medium of claim 1 wherein the important imagery of ii) comprises a region of interest of a frame and the unimportant imagery of ii) comprises another region of the frame.

5. The machine readable medium of claim 1 wherein the actions further comprise causing the sensor to capture only an expected area of interest of the image.

6. The machine readable medium of claim 1 wherein ii) above further comprises discarding the unimportant imagery.

7. The machine readable medium of claim 1 wherein the actions further comprise removing unimportant information from a captured version of the image.

8. The machine readable medium of claim 7 wherein the removing further comprises compressing a region of interest found within the captured version of the image.

9. The machine readable medium of claim 1 wherein the actions further comprise compressing a captured version of a first image that is more sensitive to image quality with a lower compression ratio than a captured version of a second image that is less sensitive to image quality.

10. The machine readable medium of claim 1 wherein the actions further comprise compressing one part of a region of interest within the image at a different compression ratio than another part of the region of interest.

11. A computing system, comprising:
one or more processing cores;
a system memory;
a memory controller coupled to the system memory;
an integrated stacked and/or abutted sensor, memory and processing hardware camera solution, wherein:
the sensor is to receive light from an image and generate electronic pixels from the light;
the processing hardware is to process the electronic pixels to:
a) recognize a scene from the image in a lower quality image mode;
b) trigger actions by the camera solution in response to the recognition of the scene, the actions comprising the following:
i) transitioning the camera solution from the lower quality image mode to a higher quality image mode to capture a higher quality version of the image; and,
ii) forwarding from the camera solution important imagery and not forwarding from the camera solution unimportant imagery.

12. The computing system of claim 11 wherein the memory is to store the electronic pixels to capture the image.

13. The computing system of claim 11 wherein, with respect to ii), the camera solution forwards the important imagery to any of:
a) a display;
b) an image signal processor;
c) the memory controller.

14. The computing system of claim 11 wherein the important imagery of ii) comprises a first frame having a feature of interest and the unimportant imagery of ii) comprises a second frame that does not have the feature of interest.

15. The computing system of claim 11 wherein the important imagery of ii) comprises a region of interest of a frame and the unimportant imagery of ii) comprises another region of the frame.

16. The computing system of claim 11 wherein the actions further comprise causing the sensor to capture only an expected area of interest of the image.

17. The computing system of claim 11 wherein ii) further comprises discarding the unimportant imagery.

18. The computing system of claim 11 wherein the actions further comprise removing unimportant information from a captured version of the image.

19. An apparatus, comprising:
an integrated stacked and/or abutted sensor, memory and processing hardware camera solution, wherein:
the sensor is to receive light from an image and generate electronic pixels from the light;
the processing hardware is to process the electronic pixels to:
a) recognize a scene from the image in a lower quality image mode;
b) trigger actions by the camera solution in response to the recognition of the scene, the one or more actions comprising at least one of:
i) transitioning the camera solution from the lower quality image mode to a higher quality image mode to capture a higher quality version of the image;
ii) forwarding from the camera solution important imagery and not forwarding from the camera solution unimportant imagery.

20. The apparatus of claim 19 wherein, with respect to ii), the camera solution forwards the important imagery to any of:
a) a display;
b) an image signal processor;
c) the memory controller.
